(19) United States
(12) Patent Application Publication
(10) Pub. No.: US 2008/0141549 A1
(43) Pub. Date: Jun. 19, 2008

(54) Measuring tape with slotted end flange for guiding a tool tip, and method of using same

(76) Inventor: James A. Brown, Garden City, MI (US)

Correspondence Address: CARRIER BLACKMAN AND ASSOCIATES, 24101 NOVI ROAD, SUITE 100, NOVI, MI, 48375, US

(21) Appl. No.: 12/001,394

(22) Filed: Dec. 11, 2007

Related U.S. Application Data
(60) Provisional application No. 60/842,078, filed on Dec. 13, 2006.

(51) Int. Cl. G01B 3/10

(52) U.S. Cl. 33/755

(57) ABSTRACT

A measuring tape apparatus includes a housing, and a tape disposed in the housing and having measuring indicia thereon. The tape has a first end inside of the housing, and a free end which is slidably removable from the housing. An L-shaped end flange is attached to the free end of the tape, for use in aligning the tape with a work piece. The end flange includes a connection section which is oriented substantially parallel to the tape, and an alignment section, substantially perpendicular to the connection section, for contacting an edge portion of a work piece. Rivets are provided to connect the end flange to the tape. The connection section also has a slot formed therein, extending laterally across the flange. The slot is adapted to receive a tip portion of a knife or marking implement therethrough, and may have a side edge which is substantially parallel to the alignment section.

### CROSS REFERENCE TO RELATED APPLICATIONS

This application claims the benefit under 35 USC 119(e)(1) and 37 CFR 1.78 of U.S. Provisional application No. 60/842,078, filed 13 Dec. 2006. The entire disclosure of this document is incorporated by reference herein.

### BACKGROUND OF THE INVENTION

1. Field of the invention

The present invention relates to hand tools, and particularly to retractable measuring tapes. More particularly, the present invention relates to a measuring tape having an angled end flange provided with a guide slot therein, for guiding movement of a tool tip. The tool tip may comprise a writing implement or a knife blade for scribing or marking materials to be cut.

2. Description of the Background Art

The construction industry has become very competitive in recent times, and any time saving or money saving device that can aid the contractor to complete the task quickly and easier is welcomed. Often, a contractor may be working alone at a job site. This can be a disadvantage when large pieces of material need to be measured and cut for use. Prior methods would have employed a chalk line or straight edge that would require two people for completion of the task. It is not cost effective to waste the time of more than one person on a job site. The need for more than one person on a job site may deplete the profit for the contractor. It is also advantageous to have a device that accurately completes the task at had without constant dry fitting of the cut material to see if it fits into the desired location. Thus, any device that saves time and money is advantageous to the contractor.

In the construction industry, there is a recurring need for measuring, marking and cutting tools for use in connection with planar materials such as plasterboard, commonly referred to in the trade as drywall. Other planar materials such as plywood and OSB (oriented strand board) are also commonly used in the construction industry. These materials are used in roofing, wall and ceiling construction, both indoors and outdoors. Drywall is commonly used as an indoor wall or ceiling member attached to the wall studs by screws or nails. Often, in repair work and new construction work, full sheets of these planar materials are not needed to complete the task. Often, a single worker, such as a homeowner, who has no additional help available, is attempting to complete these tasks.

Conventional retractable tape measures include a coiled, spring-loaded metal tape with measurement markings thereon, and a housing for storing the tape. An internal end of the tape is attached to a retraction mechanism inside the housing, whereby the tape can be automatically retracted inside the housing for storage.

Conventional tape measures typically also include a locking mechanism, so the tape can be locked at various extended positions during use. Also, conventional tape measures often include an L-shaped flange at the free end of the tape, including a downwardly depending tab that can be engaged with the edge of a work surface. This tab serves a dual purpose in that it prevents the tape from fully retracting into the housing and it acts as a stop or catch on the edge of the item to be measured.

Flat construction materials such as drywall, insulating foam board, plywood and oriented-strand board (OSB) is sold in standard sizes, such as four feet wide by eight feet long and up to four feet by sixteen feet. When installing this type of material during new construction or home improvement, it is often necessary to cut off a strip of uniform width from a standard sheet, in order to fit the material properly into a particular space. It is also very important to provide tight seams for drywall construction and straight lines produce better seams than crooked lines.

One method currently used for marking a section of a work piece to be cut is to place the reel of a tape measure at the top edge of the material sheet, extend the tape measure down to the desired width, and mark each side of the board where a cut is to be made. A chalk line or pencil may be used to make this marking. The material sheet is then cut along the marked line with a utility knife. This method requires several additional tools and steps which waste the time of the contractor or user. It would be advantageous to measure and cut in one step without the need for additional costs, such as additional tools or labor and material waste.

Alternately, one may align the housing of the tape measure with an edge of the work piece with one hand, and hold a knife or marker at the free end of the tape with the other hand, and then move the two ends of the tape along the work piece together, in an effort to draw or score a parallel line. However, when using conventional tape measures, it may be difficult to hold the knife or marker firmly in position at the end of the tape. This is most evident to the inexperienced or “do-it-yourselfer” attempting to perform such a maneuver.

A number of specialized tools are known and commercially available for marking and cutting a flat sheet of material. In particular, a number of different specialized measuring tapes and measuring tape accessories are known, for permitting a user to mark a work piece using a pencil, or to or score a work piece using a knife, as the work piece is being measured. Examples of some of the known measuring tapes and accessories include U.S. Pat. No. 4,255,856 to Mackie, U.S. Pat. No. 5,016,360 to Starcevich, U.S. Pat. No. 5,542,184 to Beard, U.S. Pat. No. 5,782,007 to Harris, U.S. Pat. No. 5,845,412 to Arcand, U.S. Pat. No. 5,979,063 to Pritz, U.S. Pat. No. 6,070,338 to Garity, U.S. Pat. No. 6,115,931 to Arcand, U.S. Pat. No. 6,212,787 to Dixon, U.S. Pat. No. 6,442,860 to Williams, U.S. Pat. No. 6,694,622 to Kim, and U.S. Pat. No. 6,912,799 to Smith.

Although the known devices are usable for their intended purposes, a need still exists in the art for an improved tape measure apparatus for use in enabling professional and amateur users to easily mark or score a work piece at a measured distance from an edge thereof. Particularly, the prior art tends to comprise “add-on” devices for tape measures that accommodate either a sharp edge like a knife or a marking device such as a pencil. These devices also tend to be quite large or cumbersome and require the tape measure to remain extended from the case, even if only a small amount. In particular, there is a need for a tape measure having a marking and scoring guide formed at an end portion of the tape, and which is relatively simple and inexpensive to manufacture.

### SUMMARY OF THE INVENTION

The present invention provides a measuring tape apparatus for use in construction and related industries, in which the apparatus includes an angled end flange provided with a guide slot therein, for guiding movement of a tool tip. This guide slot may be used with a knife point for scoring a cut line on a work piece, or alternatively, may be used to guide movement of a tip end of a marking device, such as a pen or pencil, to mark a line on a work piece.

It is an object of the invention to provide an apparatus that is unobtrusive and allows normal usage of the tape measure, such as without requiring the user to compensate by adding fractions of an inch to a measurement.

It is a further object of the invention to provide an apparatus that is cheaply made and could be provided on the tape measure without requiring major modifications to the tape measure.

A measuring tape apparatus according to an illustrative embodiment of the invention includes a housing, and a tape disposed in the housing and having measuring indicia thereon. The tape has a first end inside of the housing, and a free end which is slidably removable from the housing. An L-shaped end flange is attached to the free end of the tape, for use in aligning the tape with a work piece. The end flange includes a connection section which is oriented substantially parallel to the tape, and an alignment section, oriented substantially perpendicular to the connection section, for contacting an edge portion of a work piece. Rivets or other known types of fasteners are provided to connect the end flange to the tape. The connection section also has a slot formed therein, extending laterally across the flange. The slot is adapted to receive a tip portion of a knife or marking implement therethrough. The slot has a side edge which is substantially parallel to the alignment section.

It should be understood that only structures considered necessary for illustrating selected embodiments of the present invention are described herein. Other conventional structures, and those of ancillary and auxiliary components of the system, will be known and understood by those skilled in the art.

### BRIEF DESCRIPTION OF THE DRAWINGS

FIG. 1 is a perspective view of a tape measure apparatus according to an illustrative embodiment of the invention, shown measuring a work piece, and with a utility knife also shown in phantom.

FIG. 2 is a detail perspective view of a free end portion of the tape measure apparatus of FIG. 1, showing an L-shaped end flange on a free end of a measuring tape thereof.

FIG. 3 is a top plan view of the free end portion of FIG. 2.

FIG. 4 is a detail end plan view of the end flange, work piece and knife of FIG. 1, partially cut away.

FIG. 5 is a detail perspective view of a free end portion of a tape measure apparatus according to a second embodiment, showing a modified end flange on a free end of a measuring tape thereof.

FIG. 6 is a top plan view of the free end portion of FIG. 5.

### DETAILED DESCRIPTION OF ILLUSTRATIVE EMBODIMENTS

For a more complete understanding of the present invention, the reader is referred to the following detailed description section, which should be read in conjunction with the accompanying drawings. Throughout the following detailed description and in the drawings, like numbers refer to like parts

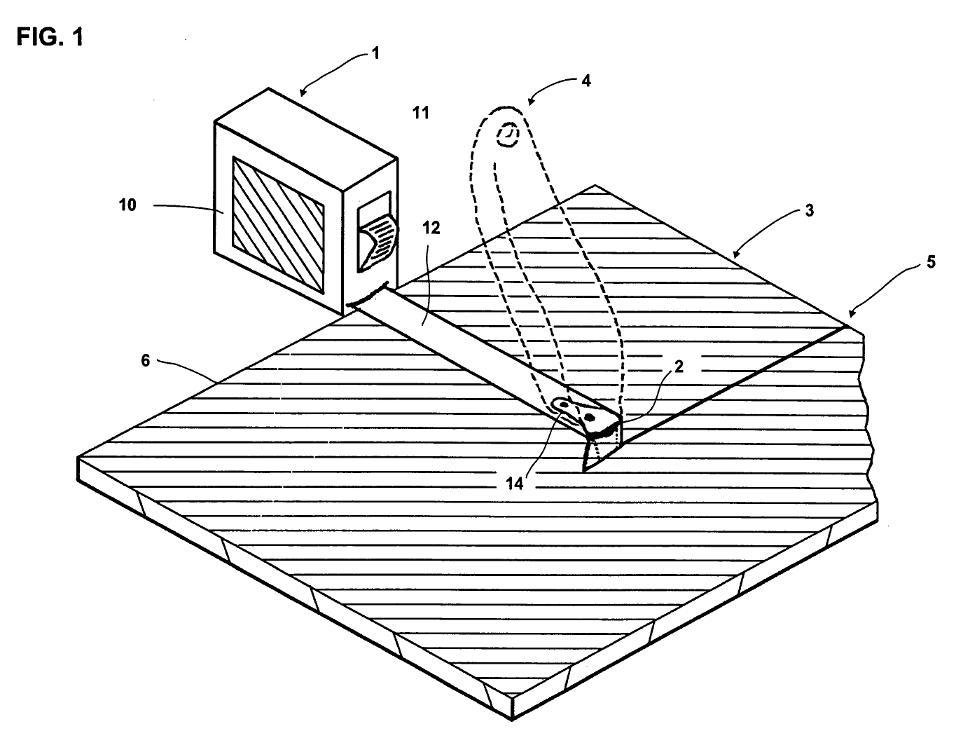

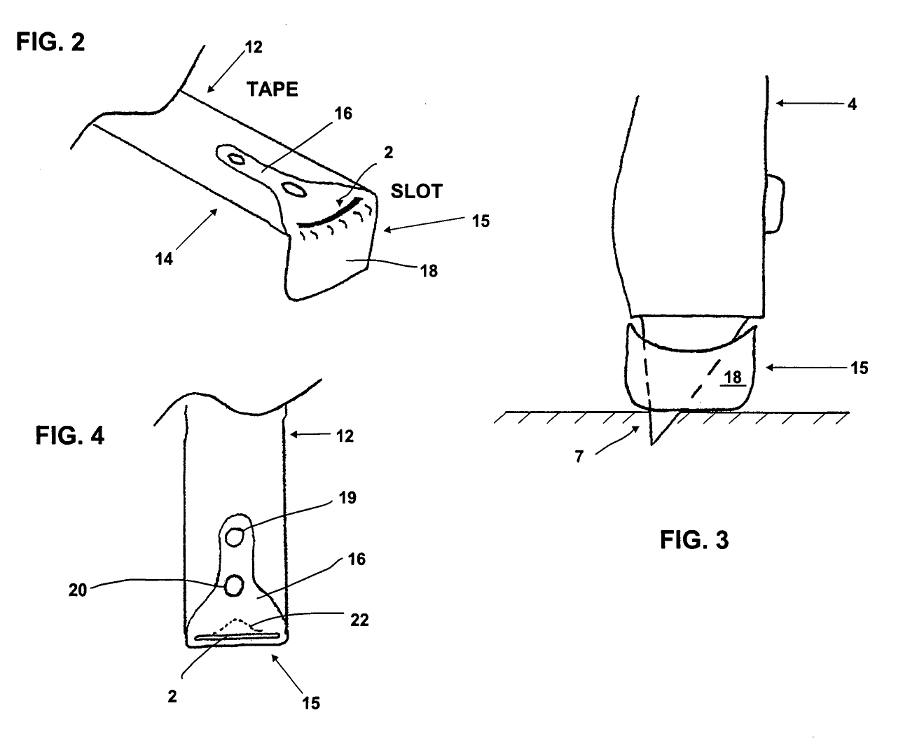

Referring now to FIGS. 1-4 of the drawings, a measuring tape apparatus, according to a first illustrative embodiment of the present invention is shown generally at 1, and is provided for use in construction and related industries, and also by homeowners.

The measuring tape apparatus 1 according to the first embodiment of the invention includes a housing 10, and a tape 12 extendably and retractably disposed in the housing and having measuring indicia thereon. The housing may also be provided with a locking mechanism 11, so the tape 12 can be locked at various extended positions during use. The tape 12 has a first, or proximal end (not shown) disposed inside of the housing, and a distal or free end 14 which is slidably removable from the housing.

An L-shaped end flange 15 is attached to the free end 14 of the tape 12, for use in aligning the tape with a work piece 3. The end flange 15 includes a connection section 16, arranged on top of and oriented substantially parallel to the tape 12, and an alignment section 18. The alignment section 18 is oriented substantially perpendicular to the connection section 16, and is provided for contacting an edge portion of a work piece 3. Rivets 19, 20 are provided to connect the end flange to the tape, although other known fasteners may be provided to attach the flange to the tape. Such an arrangement allows the L-shaped flange 15 to be available for measuring and scoring and does not interfere with other uses of the tape measure. In addition, the tape measure may still fully recoil into the housing 10.

The connection section 16 may have enlarged holes formed therein where the rivets 19, 20 pass therethrough, to allow limited movement of the end flange 15 relative to the tape 12, in order to compensate for the width of the alignment section 18 when a measurement is taken with the alignment section abutting against an edge of the work piece 3. The connection section or portion is preferably substantially triangular in shape having a narrow end where the rivets pass therethrough and a wide end where the slot is formed adjacent the alignment section or portion. This shape allows the tape measure to fully retract into the housing since the flange 15 and connection section 16 is smaller than the aperture in the housing. This shape minimizes material usage while still providing sufficient strength and attachment surface for the flange 15.

In a first embodiment of the measuring tape apparatus 1 according to the invention, the connection section 16 also has a slot 2 formed therein, oriented transverse to the longitudinal centerline of the tape 12, and extending laterally across the flange 15. The slot 2 is adapted to receive a tip portion of a knife 4, pencil (not shown) or other marking or writing implement therethrough such that the center line of the marking implement is substantially aligned at the distal end of the tape measure. The slot has an outer side edge which is substantially parallel to the alignment section. It will be understood that if desired, a central portion of the slot 2 may be enlarged, such as extended to the dotted line 22 in FIG. 4, to accommodate a tip end of a pen or pencil.

As best seen in FIG. 3, the alignment section 18 is between the knife edge and the outer portion of the measuring tape and thus acts as a guard protecting the user from possible harm when the device is in use. The knife blade will be positioned beneath the tape measure and behind the alignment section or portion protecting the user from the sharp edge of the knife blade.

In use, the housing 10 of the tape measure apparatus 1 is aligned with an edge 6 of a work piece 3 with one hand, and the tape 12 is extended to a desired length, and is then locked in place relative to the housing 10 using the locking mechanism 11. A blade 7 (best seen in FIG. 3) of a knife 4, or a writing tip of a writing implement (not shown) such as a pen or pencil, is inserted through the slot 2 at the free end 14 of the tape 12 with the other hand. The two ends of the tape apparatus 1 are then moved along the work piece together to draw or score a line 5 (best seen in FIG. 1) which is parallel to the edge 6 of the work piece 3. Once the drywall is scored, it can be easily broken to the desired size by “snapping” the drywall and cutting the paper on the opposite side. Other, harder materials, such as plywood, would need to be cut using another tool, such as a circular saw, by following the marking or score line. It will be understood that the provision of the slot 2 allows the tip 7 of the knife 4, or the writing tip of a marker to be held steadier, and more reliably, than would otherwise be possible with a conventional tape measure.

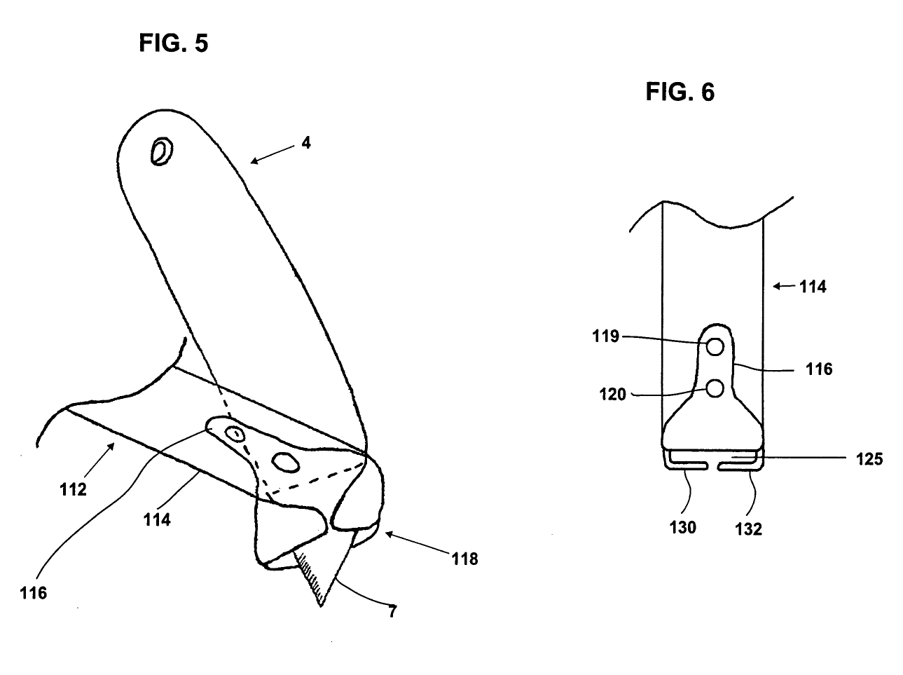

Referring now to FIG. 5, a distal end of a tape 112 of a measuring tape apparatus, according to a second illustrative embodiment of the invention is shown. It will be understood that all aspects of the measuring tape apparatus according to the second embodiment are substantially identical to the measuring tape apparatus 1 of the first embodiment, as previously described, except the configuration of the end flange 115, as subsequently described herein.

The measuring tape apparatus according to the second embodiment of the invention includes a housing similar to that shown at 10, and a tape 112, extendably and retractably disposed in the housing and having measuring indicia thereon. The tape 112 has a first, or proximal end (not shown) disposed inside of the housing, and a distal or free end 114 which is slidably removable from the housing.

A substantially L-shaped end flange 115 is attached to the free end 114 of the tape 112, for use in aligning the tape with a work piece 3. The end flange 115 includes a connection section 116, arranged on top of and oriented substantially parallel to the tape 112, and an alignment section 118. The alignment section 18 is oriented substantially perpendicular to the connection section 116, and is provided for contacting an edge portion of a work piece 3. Rivets 119, 120 are provided to connect the end flange 115 to the tape 112. The rivets 119, 120 are affixed to the tape 112.

The connection section 116 may have enlarged holes formed therein where the rivets 119, 120 pass therethrough, to allow limited movement of the end flange 115 relative to the tape 112, in order to compensate for the width of the alignment section 118 when a measurement is taken with the alignment section abutting against an edge of the work piece 3.

In this second embodiment, the end flange 115 is also provided with a pair of side tabs 130, 132 extending outwardly from side edges of the alignment section 118, and these side tabs are bent around 180 degrees so that they extend inwardly toward one another, as shown in FIGS. 5-6. The side tabs 130, 132 define a guide slot 125 between the tabs and the main body of the alignment section 118. This guide slot 125 functions substantially identical to the guide slot 2 of the first embodiment, as described herein, to receive and guide a blade tip 7 of the tip of a marking tool therein.

The flange 15, 115 may be formed by a variety of methods, including conventional machining, molding and casting, injection molding or other plastic working techniques, or other metal forming techniques.

Although the present invention has been described herein with respect to a limited number of illustrative embodiments, the foregoing description is intended to be illustrative, and not restrictive. Those skilled in the art will realize that many modifications of the described embodiments could be made which would be operable. All such modifications, which are within the scope of the claims, are intended to be within the scope and spirit of the present invention.

What is claimed is:

1. A measuring tape apparatus, comprising:
a housing;
an extendable and retractable tape disposed in the housing and having measuring indicia thereon, said tape having a proximal end disposed within the housing and a free distal end which is removable from the housing;
an angled end flange attached to the free end of the tape, for aligning the tape with a work piece, said end flange having a connection section aligned in parallel with the free end of the tape, and an alignment section for selectively placing in contact with an edge portion of a work piece, said alignment section being oriented substantially perpendicular to said connection section;
wherein said connection section has at least two holes formed therein to receive rivets which connect the flange to the tape;
and wherein said flange has a slot formed therein, where said slot is dimensioned and configured to receive a tip portion of a knife blade or a marking implement therethrough, said slot having a side edge which is substantially parallel to said alignment section.

2. The measuring tape apparatus of claim 1, wherein said connection section is substantially the width of said tape.

3. The measuring tape apparatus of claim 1, wherein said slot is provided such that the centerline of a marking device is substantially aligned with said free end of the tape.

4. The measuring tape apparatus of claim 1, wherein said angled end flange is substantially L-shaped with said slot provided such that the centerline of a marking device is substantially aligned with the end of said tape.

5. The measuring tape apparatus of claim 1, wherein said slot is located adjacent said alignment section in said connection section.

6. The measuring tape apparatus of claim 1, wherein said slot is formed transverse to the longitudinal axis of the measuring tape in said connection section.

7. The measuring tape apparatus of claim 1, wherein said slot is formed by a pair of tabs extending from either side of said alignment section, said slot defined by said tabs and said alignment section.

8. The measuring apparatus of claim 1, wherein said alignment section includes a pair of side tabs, said side tabs forming said slot by bending around said alignment section,
said slot defined by said tabs and the front portion of said alignment section, and
said tabs having a length such that the ends of each tab are spaced apart when bent to form said slot.

9. The measuring apparatus of claim 1, wherein said alignment section comprises a front, a back, a first side, a second side, a top and a bottom,
said top joins to said connection section,
said first side and said second side have corresponding first tab and second tab, and
said first and second tabs bent over said front towards one another to form said slot with said front.

10. A guide for a free end of a measuring tape apparatus, the guide adapted to receive a marking device, the measuring tape apparatus having a housing, a retractable and extendable measuring tape therein, one end of the measuring tape secured within said housing, the opposite end of said measuring tape extending through an aperture in said housing, and a locking mechanism for temporarily and disengagably locking the measuring tape in an extended position, wherein:
said guide comprises an L-shaped flange, said flange having a connection portion and an alignment portion,
said connection portion adapted to be secured to the measuring tape,
said alignment portion substantially perpendicular to said connection portion and adapted to contact the edge of a member to be measured with said measuring tape,
said connection portion further having a slot therein formed transverse to the longitudinal centerline of said measuring tape and adapted to receive a marking device.

11. The guide of claim 10, wherein said slot includes an enlarged center portion.

12. The guide of claim 10, wherein said slot is positioned to receive said marking device such that the center line of said marking implement is substantially aligned with the end of said measuring tape.

13. The guide of claim 10, wherein said marking device is a knife having a blade extending therefrom.

14. The guide of claim 10, wherein said marking device is writing implement.

15. The guide of claim 10, wherein said guide secures to said tape measure by rivets through said connection portion,
said connection portion being substantially the width of the tape measure,
said slot having an outer edge substantially parallel to said alignment portion.

16. The guide of claim 10, wherein said connection portion is secured to said tape measure by rivets, said rivets pass through a narrow end of said connection portion and said slot is positioned at a wide end of said connection portion, such that said connection portion is substantially triangular in shape.

17. The guide of claim 10, wherein said guide secures to said tape by rivets through said connection portion,
said connection portion comprising a narrow end where said rivets pass through and a wide end where said slot is positioned, said wide end being substantially the width of the tape measure, said connection portion being substantially triangular in shape, and
said slot having an outer edge substantially parallel to said alignment portion.

18. The guide of claim 10, wherein said alignment portion is positioned between said marking device and a user to act as a guard.

19. The guide of claim 10, wherein said marking device is a knife having a blade extending therefrom, said slot in said connection portion sized to accept said knife blade,
said alignment portion acts as a guard between said blade and a user such that the blade is beneath said tape measure and behind said alignment portion.

20. The guide of claim 10, wherein said slot is sized to receive a blade of a knife and having an outer edge substantially parallel to said alignment portion,
said connection portion secured to said tape measure by rivets, said rivets allowing movement of said flange relative to said tape to compensate for the width of said alignment portion.
